(19) United States
(12) Patent Application Publication
(10) Pub. No.: US 2023/0264418 A1
(43) Pub. Date: Aug. 24, 2023

(54) MULTIPHASE DIRECT INK WRITING FOR MULTILAYERED COMPOSITES

(71) Applicants: Dharneedar Ravichandran, Tempe, AZ (US); Weiheng Xu, Chandler, AZ (US); Mounika Kakarla, Tempe, AZ (US); Sayli Jambhulkar, Gilbert, AZ (US); Yuxiang Zhu, Gilbert, AZ (US); Kenan Song, Gilbert, AZ (US)

(72) Inventors: Dharneedar Ravichandran, Tempe, AZ (US); Weiheng Xu, Chandler, AZ (US); Mounika Kakarla, Tempe, AZ (US); Sayli Jambhulkar, Gilbert, AZ (US); Yuxiang Zhu, Gilbert, AZ (US); Kenan Song, Gilbert, AZ (US)

(21) Appl. No.: 18/170,950

(22) Filed: Feb. 17, 2023

Related U.S. Application Data
(60) Provisional application No. 63/311,813, filed on Feb. 18, 2022.

(51) Int. Cl. B29C 64/209; B29C 64/118; B33Y 30/00; B33Y 10/00

(52) U.S. Cl. CPC B29C 64/209; B29C 64/118; B33Y 10/00; B33Y 30/00; B29K 2029/04

(57) ABSTRACT

An additive manufacturing print head includes a spinneret defining a first channel configured to receive a first feedstock and a second channel configured to receive a second feedstock. The spinneret is configured to provide a bilayer extrudate including a layer of the first feedstock in direct contact with a layer of the second feedstock. The print head further includes a minimizer configured to receive the bilayer extrudate from the spinneret and to reduce a flow area of bilayer extrudate transverse to a flow direction of the bilayer extrudate, and a multiplier configured to transform the bilayer extrudate from the minimizer to a multilayer extrudate. The multilayer extrudate includes alternating layers of the first feedstock and the second feedstock.

### CROSS-REFERENCE TO RELATED APPLICATION

This application claims the benefit of U.S. Pat. Application No. 63/311,813 filed on Feb. 18, 2022, which is incorporated herein by reference in its entirety.

### TECHNICAL FIELD

This invention relates to additive manufacturing (3D printing) methods and devices used to fabricate multilayered and multiphased composite structures.

### BACKGROUND

Additive manufacturing, commonly known as three-dimensional (3D) printing, is a manufacturing technique that builds an object by depositing, joining, or solidifying material in a layer-by-layer manner. 3D printing has advantages over traditional manufacturing with respect to rapid prototyping, complicated design, and material sustainability.

### SUMMARY

This disclosure describes additive manufacturing (3D printing) processes and devices for the fabrication of alternatively layered composites within each printing line. The layered structures are achieved by co-extruding two immiscible feedstocks with matched viscosities through a print head configured to form continuous ink deposited structures fabricated along a plane transverse to the flow direction of feedstock extrusion (x-y plane). The method is compatible with natural and synthetic polymers, as well as biopolymers. In one example, polyvinyl alcohol (PVA)-multiwalled nanotube (MWNT) composites are fabricated from PVA solutions and MWNTs suspensions with matched viscosities.

In a first general aspect an additive manufacturing print head includes a spinneret defining a first channel configured to receive a first feedstock and a second channel configured to receive a second feedstock. The spinneret is configured to provide a bilayer extrudate including a layer of the first feedstock in direct contact with a layer of the second feedstock. The first general aspect further includes a minimizer configured to receive the bilayer extrudate from the spinneret and to reduce a flow area of bilayer extrudate transverse to a flow direction of the bilayer extrudate, and a multiplier configured to transform the bilayer extrudate from the minimizer to a multilayer extrudate. The multilayer extrudate includes alternating layers of the first feedstock and the second feedstock.

Implementations of the first general aspect can include one or more of the following features.

The first general aspect can further include a reducer configured to receive the multilayer extrudate from the multiplier and to modify the dimensions of the multilayer extrudate in a plane transverse to the flow direction of the multilayer extrudate. In some implementations, the multiplier is configured to transform the bilayer extrudate to a four-layer extrudate. In some cases, the first general aspect further includes an additional multiplier configured to receive the multilayer extrudate from the multiplier and to double a number of alternating layers of the multilayer extrudate. In some implementations, the first general aspect further includes a reducer configured to receive the multilayer extrudate from the additional multiplier and to modify the dimensions of the multilayer extrudate in a plane transverse to the flow direction of the multilayer extrudate. The multiplier and the additional multiplier can be configured to transform the bilayer extrudate to an eight layer extrudate.

In some cases, the first general aspect includes one or more additional multipliers, wherein a total number of multipliers is n. The multiplier and the one or more additional multipliers can be configured to transform the bilayer extrudate to a multilayer extrudate having 2⁽ⁿ⁺¹⁾ layers. In some implementations, the first general aspect further includes (n-1) additional multipliers coupled in series. Each of the (n-1) additional multipliers can be configured to double a number of alternating layers of the multilayer extrudate provided to the each of the (n-1) additional multipliers. In some cases, the first general aspect further includes a reducer configured to receive the multilayer extrudate from the (n-1) additional multipliers and to modify a dimension of the multilayer extrudate in a plane transverse to the flow direction of the multilayer extrudate. A printer can include the first general aspect.

In a second general aspect, fabricating a multilayer extrudate includes co-extruding a first feedstock and a second feedstock to yield a bilayer extrudate. The bilayer extrudate includes a layer of the first feedstock in direct contact with a layer of the second feedstock. The second general aspect further provides the bilayer extrudate to one or more multipliers to yield a multilayer extrudate. The multilayer extrudate includes alternating layers of the first feedstock and the second feedstock.

Implementations of the second general aspect can include one or more of the following features.

The first feedstock and the second feedstock can be immiscible. In some cases, a difference in viscosity between the first feedstock and the second feedstock at room temperature is approximately zero. In some implementations, the first feedstock, the second feedstock, or both include a polymer and a solvent. The polymer can include polyvinyl alcohol. In some cases, the solvent includes dimethyl sulfoxide. In some implementations, the first feedstock, the second feedstock, or both include nanostructures. The first feedstock, the second feedstock, or both can be dispersions. In some cases, the second general aspect further includes polymerizing the multilayer extrudate to yield a multilayer structure. In some implementations, providing the multilayer extrudate to the one or more multipliers includes providing the multilayer extrudate to n multipliers in series, and the multilayer extrudate includes 2⁽ⁿ⁺¹⁾ alternating layers of the first feedstock and the second feedstock.

Advantages of the multilayer additive manufacturing methods described herein include high printing speeds and high precision achieved in a one-step process. For example, deposition of multilayered composites is achieved in a single printing step with a printing speed up to 1200 mm/min and high-precision control down to approximately 4 µm. The individual printed layers containing confined MWNTs are scalable for thin-ply and laminates, blending the top-down (e.g., from the filament to submicron layers) and bottom-up (i.e., from the filament to thin-ply to laminates) protocols in one procedure. The disclosed layered composites can be used for surface patterning, layered laminates, circular scaffolds, and other functionally graded structures.

The details of one or more embodiments of the subject matter of this disclosure are set forth in the accompanying drawings and the description. Other features, aspects, and advantages of the subject matter will become apparent from the description, the drawings, and the claims.

### BRIEF DESCRIPTION OF DRAWINGS

FIG. 1A depicts an additive manufacturing printer. The magnified view depicts alternately-layered, mesostructured patterns along the plane transverse to the flow direction of feedstock extrusion. FIG. 1B depicts the additive manufacturing print head. FIG. 1C depicts the multiplier.

FIG. 2A depicts the print head spinneret and minimizer with the first feedstock and the second feedstock forming a bilayer extrudate. FIG. 2B depicts the outlet of the minimizer with the bilayer extrudate. FIG. 2C depicts the multiplier transforming the bilayer extrudate into a four-layer extrudate.

FIGS. 3A and 3B show shear rate effect on viscosity and stress, respectively, for varying weight percentage (wt%) of polyvinyl alcohol (PVA) in dimethyl sulfoxide (DMSO) in feedstock A. FIG. 3C shows viscosity as a function of PVA concentration for various shear rates for the first feedstock. FIGS. 3D and 3E show shear rate effect on viscosity and stress, respectively, in 15 wt% PVA/DMSO for different concentrations of multiwalled carbon nanotubes (MWNT) in the second feedstock. FIG. 3F shows viscosity as a function of MWNT concentration for various shear rates for the second feedstock. FIGS. 3G and 3H show shear rate effect on viscosity and stress, respectively, in 18 wt% PVA/DMSO for different concentrations of multiwalled carbon nanotubes (MWNT) in feedstock B. FIG. 3I shows viscosity as a function of MWNT concentration for various shear rates for the second feedstock.

FIGS. 4A and 4B show viscosity and stress vs. shear rate matching, respectively, between the first and second feedstocks. FIGS. 4C and 4E show viscosity and stress, respectively, for pure feedstocks and layered composite solutions (8-512 layers); FIGS. 4D and 4F show expanded regions of viscosity (FIG. 4C) and stress (FIG. 4E).

FIG. 5 shows a plot of theoretical sheer rate vs. layer number for multilayered composites.

FIGS. 6A-6G shows optical images of 4, 8, 16, 32, 64, 256, and 512 layered structures, respectively (scale bar of 500 µm). FIG. 6H shows the layer size as a function of number of layers from the experimental and theoretical calculations.

FIG. 7A shows plots of Young’s modulus and ultimate tensile strength vs. layer numbers. FIG. 7B shows a plot toughness vs. layer numbers. FIG. 7C shows stress-strain curves of all the layer samples at a 15 mm gauge length. FIG. 7D shows stress-strain curves of selected samples at a 2.5 mm gauge length.

### DETAILED DESCRIPTION

This disclosure describes additive manufacturing (3D printing) processes and devices for the fabrication of layered composites. The alternately layered composite structures are fabricated by co-extruding two immiscible feedstocks with matched viscosities through a print head configured to form continuous ink deposited structures fabricated along a plane transverse to the flow direction of feedstock extrusion (x-y plane). The method is compatible with natural polymers, synthetic polymers, and biopolymers. The disclosed methods and devices achieve a printing speed up to 1200 mm/min with high-precision control to as low as ~4 µm.

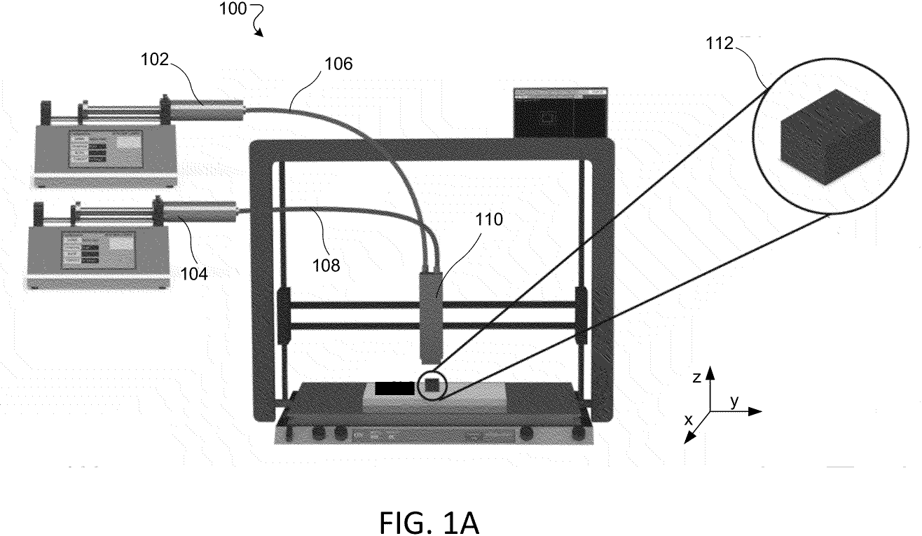

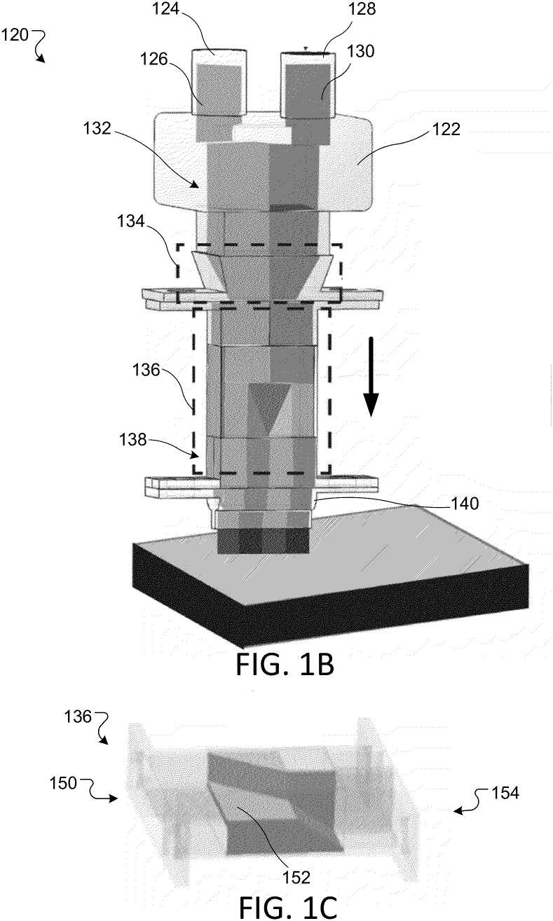

FIG. 1A depicts an additive manufacturing printer 100. A first reservoir syringe 102 containing a first feedstock and a second reservoir syringe 104 containing a second feedstock are connected by delivery tubes 106 and 108, respectively, to the additive manufacturing print head 110. Syringe pumps drive reservoir syringes 102 and 104 to deliver the first feedstock and the second feedstock through the delivery tubes 106 and 108, respectively to the additive manufacturing print head 110. The first feedstock and the second feedstock enter the additive manufacturing print head 110 and form a bilayer extrudate inside the additive manufacturing print head 110. The additive manufacturing print head 110 includes one or more multipliers that transform the bilayer extrudate into a multilayer extrudate that becomes the printed object 112 upon exiting the additive manufacturing print head 110.

FIG. 1B depicts an example of an additive manufacturing print head 120. A spinneret 122 defines a first channel 124 configured to receive the first feedstock 126 and a second channel 128 configured to receive the second feedstock 130. The spinneret 122 is configured to provide a bilayer extrudate 132 including a layer of the first feedstock 126 in direct contact with a layer of the second feedstock 130. A minimizer 134 is configured to receive the bilayer extrudate 132 from the spinneret 122 and to reduce a flow area of the bilayer extrudate 132 transverse to the flow direction of the bilayer extrudate. A multiplier 136 is configured to transform the bilayer extrudate 132 from the minimizer 134 to a multilayer extrudate 138. The multilayer extrudate 138 includes alternating layers of the first feedstock 126 and the second feedstock 130. A reducer 140 is configured to receive the multilayer extrudate 138 from the multiplier 136 and to modify the dimensions of the multilayer extrudate 138 in a plane transverse to the flow direction of the multilayer extrudate. The multilayer extrudate 138 in FIG. 1B is depicted as a four-layer extrudate. The flow direction of the bilayer extrudate and the multilayer extrudate is indicated by the direction of the arrow in FIG. 1B.

FIG. 1C depicts multiplier 136. The multiplier 136 is configured to transform a bilayer extrudate 132 into a multilayer extrudate 138. The bilayer extrudate 132 including a layer of the first feedstock 126 in direct contact with a layer of the second feedstock 128 enters the multiplier 136 from side 150. A divider 152 on the interior of multiplier 136 divides the bilayer extrudate 132 in a plane transverse to the plane defined by the contact seam of the layers of feedstock in the bilayer extrudate. The multiplier 136 transforms the divided bilayer extrudate into a multilayer extrudate 138 including alternating layers of the first feedstock 126 and the second feedstock 128. The multilayer extrudate 138 exits the multiplier 136 from side 154.

Additive manufacturing print heads described herein can include one or more additional multipliers. In some embodiments, an additional multiplier is configured to receive the multilayer extrudate from the multiplier and to double a number of alternating layers of the multilayer extrudate. A reducer is configured to receive the number of alternating layers of multilayer extrudate from the additional multiplier and to modify the dimensions of the multilayer extrudate in a plane transverse to the flow direction of the multilayer extrudate.

In some embodiments, additive manufacturing print heads include a multiplier and an additional multiplier. The multiplier and the additional multiplier are configured to transform the bilayer extrudate to an eight layer extrudate. In some embodiments, the additive manufacturing print head includes one or more additional multipliers such that a total number of multipliers is n. The one or more additional multipliers are configured to transform the bilayer extrudate to a multilayer extrudate having 2⁽ⁿ⁺¹⁾ layers.

In some embodiments, the additive manufacturing print head including a multiplier further includes (n-1) additional multipliers coupled in series. Each of the (n-1) additional multipliers is configured to double a number of alternating layers of the multilayer extrudate provided to the each of the (n-1) additional multipliers. The print head including (n-1) additional multipliers further includes a reducer configured to receive the multilayer extrudate from the (n-1) additional multipliers and to modify a dimension of the multilayer extrudate in a plane transverse to the flow direction of the multilayer extrudate.

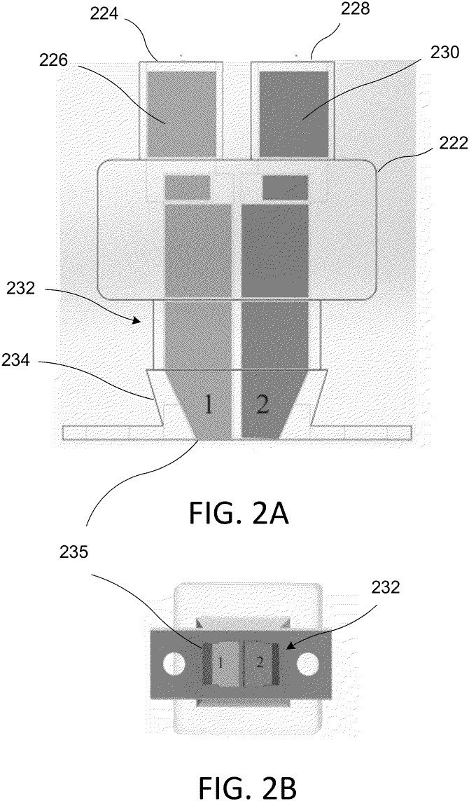

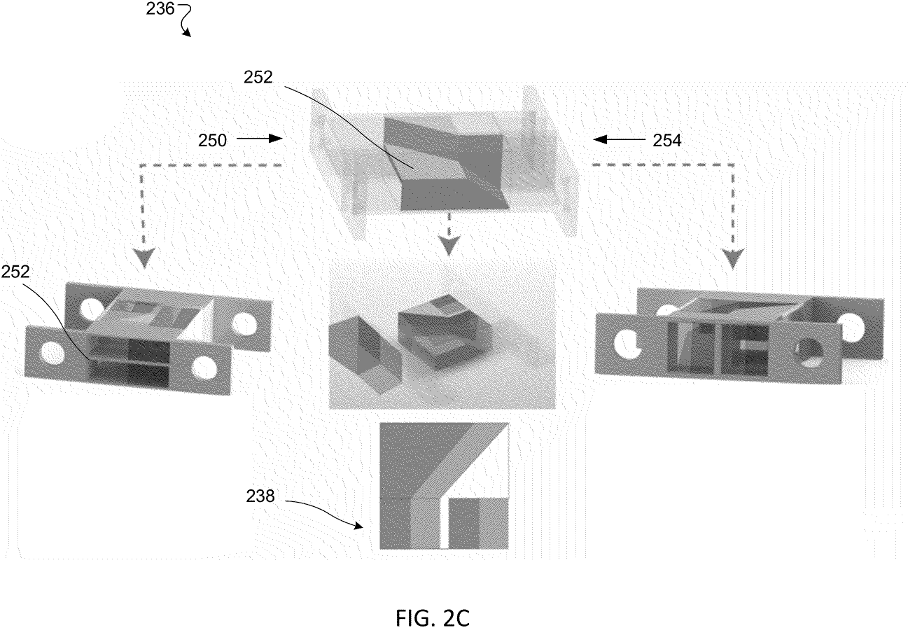

Aspects of the present disclosure provide methods of fabricating a multilayer extrudate. Methods of fabricating a multilayer extrudate include co-extruding the first feedstock and a second feedstock to yield a bilayer extrudate. As shown in FIG. 2A, the first feedstock 226 and the second feedstock 230 enter the first channel 224 and second channel 228, respectively, defined by spinneret 222. The first feedstock 226 and the second feedstock 230 are co-extruded by the spinneret 222 to yield the bilayer extrudate 232. A minimizer 234 is configured to receive the bilayer extrudate 232 from the spinneret 222. As shown in FIG. 2B, the bilayer extrudate 232 includes a layer of the first feedstock 226 in direct contact with the a layer of the second feedstock 230 at the minimizer outlet 235.

The bilayer extrudate 232 is provided to one or more multipliers 236 to yield a multilayer extrudate 238 as illustrated in FIG. 2C. The bilayer extrudate 232 exits the minimizer outlet 235 and enters multiplier 236 through side 250. The multiplier 236 transforms the bilayer extrudate 232 into a multilayer extrudate 238 that exits the multiplier through side 254. The multilayer extrudate 238 includes alternating layers of the first feedstock 226 and the second feedstock 230.

Methods of fabricating the multilayer extrudate include a first feedstock and a second feedstock having the same or different viscosities. In some embodiments, a difference in viscosity between the first feedstock and the second feedstock at room temperature is approximately zero. A similar viscosity between the first feedstock and the second feedstock can be advantageous to avoid layer breakage during printing. Immiscibility between the first feedstock and the second feedstock can be advantageous to facilitate layer integrity. Accordingly, in some embodiments, the first feedstock and the second feedstock are immiscible.

In some embodiments, the first feedstock, the second feedstock, or both include a polymer and a solvent. The first feedstock, the second feedstock, or both can include the polymer in a range of about 5 wt% to about 20 wt%. Suitable polymers include natural polymers and synthetic polymers. Natural polymers include biopolymers. In one example, the polymer includes polyvinyl alcohol. Suitable solvents include dimethyl sulfoxide.

In some embodiments, the first feedstock, the second feedstock, or both include nanostructures. Suitable nanostructures include nanoparticles of boron nitride, Mxene, iron oxide, carbon black, graphite, and carbon. Other suitable nanostructures include carbon nanotubes (e.g., single-, double-, few- and multi-walled nanotubes). In some examples, the carbon nanotubes have a diameter up to about 1 nm and a length up to about 2 microns. The feedstocks include carbon nanotubes in a concentration range of about 1.0 wt% to about 2.0 wt%.

Methods described herein include polymerizing the multilayer extrudate to yield a multilayer structure. In some cases, the multilayer extrudate is solidified through a solvent-exchange coagulation process.

The multilayer extrudate can be provided to n multipliers in series, and the resulting multilayer extrudate has 2⁽ⁿ⁺¹⁾ alternating layers of the first feedstock and the second feedstock. The number of multipliers typically ranges from 1 to 8, with the resulting multilayer extrudate having 4 to 512 alternating layers, respectively, of the first feedstock and the second feedstock.

### EXAMPLES

Polyvinyl alcohol (PVA) and nanoparticles of multiwalled carbon nanotubes (MWNTs) were used as examples in fabricating multiphased and multilayered composites. Continuous ink deposition led to thin-ply structures, with mechanical properties influenced by the layer thickness. The 64-layered structures showed much thinner layer dimensions than the 4-layered ones (e.g., 32 µm vs. 500 µm) and better layer distinctions than greater numbers of layers (e.g., 256- and 512-layered structures). As a result, the 64-layered samples showed enhanced mechanical properties relative to the PVA (i.e., 0.74 GPa/15.45 MPa vs. 0.15 GPa/5.43 MPa for modulus/strength). Compared to the 4-layered structures with the same MWNTs concentration, the 64-layered composites were ~70% greater in modulus and ~36% greater in strength. These enhanced properties are due at least in part to improved layer thickness precision, crystallization, and particle orientations.

Materials. PVA (i.e., PVA 28-98 with a molecular weight (M_{w}) of ~ 145 kg/mol, 98-99 mol% degree of hydrolysis, and CAS # 9002-89-5) was requested and provided by Kuraray. Dimethyl sulfoxide (DMSO) (American Chemical Society reagent, >99.8%, CAS #67-68-5) and methanol (>99.8%, CAS #67-56-1) solvents were purchased from Sigma-Aldrich and used as obtained. MWNTs (NC7000 series, 90% purity, with a surface area of 250-300 m²/g and an average length and diameter of 1.5 µm and 9.5 nm, respectively) were purchased from Nanocyl. All the materials were used as received.

Material Processing and Manufacturing Procedures. To fabricate multilayered structures with multiple materials, two different feedstock materials were used. The first feedstock, defined herein as feedstock A, was the PVA/DMSO solutions, and the second feedstock, defined herein as feedstock B, was the MWNTs suspensions (e.g., MWNTs dispersed in PVA/DMSO)

Different PVA weights were added to DMSO with constant mechanical stirring at 110° C. for feedstock A (i.e., 5 wt%, 10 wt%, 15 wt%, 18 wt%, and 20 wt% PVA/DMSO). For MWNTs suspensions, the nanotubes were first dispersed in DMSO using a bath sonicator for 16 hrs, then 1 wt% of the polymer was dissolved in DMSO and bath sonicated for another 16 hrs to improve the dispersion. Additional PVA was then dissolved in the solution using mechanical stirring until target PVA concentrations (i.e., 20%, 18%, and 15% PVA/DMSO) and MWNTs percentage (i.e., 1.0 wt%, 1.5 wt%, and 2.0 wt% MWNTs/PVA) were achieved. The PVA/DMSO solutions and composite suspensions were vacuum-degassed at 60° C. with 30 inches of Hg pressure for 30 minutes to eliminate bubbles.

FIG. 1A depicts the additive manufacturing (3D) printer 100 including the additive manufacturing (3D) print head 110. The PVA/DMSO solutions and MWNTs/PVA/DMSO suspensions were loaded into two separate stainless-steel syringes 102 and 104 and extruded using syringe pumps (KDS LEGATO 200 dual syringe pumps with an accuracy of +/- 0.35%) at 1.5 ml/min. The 3D printing system was based on an open-source 3D printing system (Hydra 16A 640 from Hydrorel) with a temperature controlled and closed environment (temperature range -50° C. to 200° C.). The printer had a 60 cm × 40 cm × 25 cm build volume for x, y, and z axes, respectively, where the x-y plane is defined as transverse to the flow direction of feedstock extrusion. The printer has a 150+ MHz 32-bit ARM processor and modular, micro-stepping motor drivers with closed-loop encoding. The printer has a positional accuracy of 10 µm and a printing feature of 1 µm in the z-axis for polymer melts. With PVA/DMSO solutions, the printing accuracy and fine feature values were 200 µm and 50 µm, respectively, along the x-y and z axes.

The additive manufacturing printer depicted in FIG. 1A has various components as depicted in FIGS. 1B and 1C. The print head 120 includes a spinneret 122, a minimizer 134, one or more layer multipliers 136, and a reducer 140. All the parts were designed using SolidWorks 2019 and manufactured using a Concept-Laser M2 metal 3D printer with Inconel 718. Inconel 718 is a precipitation-hardenable nickel-chromium alloy containing significant amounts of iron, niobium, and molybdenum, along with lesser amounts of aluminum and titanium. These parts were post-processed for the solutions and the suspensions to flow smoothly within the print head channels by removing the supports and polishing exterior and interior wall surfaces. These customized parts were connected using nuts and bolts. The number of multipliers varied depending on the desired layer numbers to produce in the composites.

Characterization. The rheology tests were conducted via a rheometer (Discover Hybrid Rheometer HR2, TA Instruments). The viscosity of each sample composition was measured using a cone-and-plate geometry. The samples of 2 ml were dropped on a 40 mm, 2° Peltier cone steel plate. The viscosity values were measured with varying shear rates (e.g., 0.001 /s to 8000 /s), 100 µm truncation gap, and 50 µm trim gap offset at room temperature. The feedstock was overfilled to avoid rheology edge fracture, with the excess solutions removed before the beginning of each run. Each sample was tested three times to prevent system errors. The rheological behavior of layered structures was also tested via plate-and-plate geometry. The 8 mm disposable aluminum parallel plates were used to observe the variation in viscosity and stress as a function of material layer numbers within varying shear rates (0.01 /s to 1000 /s). The geometry gap between the parallel plate at room temperature was 100 µm.

The multilayered morphology was observed using an optical microscope (OM) (Nikon eclipse E200 and Olympus MX50) to identify the size and number of layers for individually printed lines. Raman spectroscopy analysis (Raman spectrum and Raman mapping) was conducted using confocal Raman-AFM microscopy (WITec alpha 300 RA) with a 532 nm laser to detect the MWNTs VV configuration (polarization of the incident light parallel to the fiber axis). The samples were scanned at 0° and 90° for each polarized angle with a fixed laser polarization configuration. A differential scanning calorimetry (DSC) (Discovery DSC 250, TA Instruments) was performed with a modulated mode, from room temperature to 280° C. at 5° C./min temperature ramp for a sample size of ~10 mg. The temperature modulation was 2° C. for 60 sec. X-ray diffraction (XRD) was conducted using an Aeris X-ray diffractometer (Malvern Panlytical) from 5° to 70° for a period of 15 minutes at 0.09°/s. The tensile test was conducted with a tensile tester (Discover Hybrid Rheometer HR2, TA Instruments) at room temperature with a constant linear rate of 100 µm /s. The tension gauge length was 15 mm long for samples with a thickness of 200-250 µm, measured using an optical microscope (Olympus MX50). The printed materials showed high tensile strains, and a smaller gauge length (e.g., ~2 mm) was used to show fracture behaviors of the samples. The samples were air-dried for one day and kept in the desiccator for another 24 hrs to remove the solvent residue before conducting all tests (e.g., mechanical testing, Raman, DSC, XRD).

Results. The disclosed 3D printing system was optimized to produce high quality prints feature at maximum speed without sacrificing the phase domain size in additive printing. The control of these phase domain size is a factor in the application of layered structures, as this printing feature influences the distribution of nanoparticles and their reinforcement effects. The 3D printing system has a printing speed of ~1200 mm/min and a printing feature size as low as ~4 µm, two orders of magnitude lower than many reported minimum printing feature sizes using conventional 3D printing methods.

FIG. 1A depicts the additive manufacturing printer 100. Two materials, feedstock A of the PVA/DMSO solutions and feedstock B of MWNTs suspensions, are loaded into two syringes 102 and 104 and injected via the action of the syringe pumps to the print head 110. Unlike conventional additive manufacturing printing, the disclosed additive manufacturing printing process can produce layered microstructures containing alternating compositions along the x-y plane within each printing line or layer (i.e., polymer and nanoparticle content in alternating layers). The printed microlayers and macrolayers undergo solidification processes. The thin-ply materials serve as a basis for more complex structures. Furthermore, the individual printed microlayers containing confined nanotubes are scalable for thin-ply and laminates, blending the top-down (i.e., from the filament to submicron layers) and bottom-up (i.e., from the filament to thin-ply to laminates) protocols in one procedure.

The 3D printer has various components, namely, the machine controls for deposition sites, injection controls via the syringe pumps, reservoir syringes 102 and 104 containing feedstock A/B, respectively, delivery tubes 106 and 108 for the transportation of the feedstock to the print head, additive manufacturing print head 110 and the printed object 112 on the printing substrates. The print head 110 is configured to achieve mesoscale, multilayered structures as depicted in FIG. 1B. Feedstock A 126 (e.g., PVA/DMSO solutions) and B 130 (e.g., MWNTs/PVA/DMSO suspensions) enter the spinneret 122, minimizer 134, one or more layer multipliers 136, and a reducer 140. A minimizer 134 is used between the spinneret 122 and the layer multiplier 136 to reduce the flow area and increase the shear for layer formations with minimal flow disturbance (e.g., feedstock temperature, viscosity, flow rate, and internal smoothness of the print head). Feedstocks A and B are split horizontally within each multiplier 136, stacked, and stitched vertically to form alternating layers of both the feedstocks. In this way, having one multiplier 136 attached to the spinneret 122 produced four alternating layers. Similarly, the number of n multipliers will generate alternating layers in the order of 2⁽ⁿ⁺¹⁾ along the printing line direction in the x-y plane. In this way, the additive manufacturing printing speed in a unit of ml/min depends at least in part on the nozzle dimensions. Simultaneously, the nozzle size increase does not sacrifice the printed phase domain size determined by the multiplier numbers instead of the printing head design. A reducer functions as a regulator to modify the filamentary shape and cross-section size. The printed objects were dried for respective property tests with proper solvent exchange followed by proper post-treatment (e.g., air dry in a desiccator for 24 hours to eliminate residue solvent).

FIGS. 2A-2C show the details of the layer formation. The two feedstocks entered two separate channels of the spinneret at 1.5 ml/min (i.e., 25 mm³/sec) as shown in FIG. 2A, forming a side-by-side stacked bilayer extrudate. The bilayer extrudate 232 is illustrated at the output 235 of the minimizer 234. in FIG. 2B. The multiplier depicted in FIG. 2C includes three parts: the inlet 250, the outlet 254, and the central part called the divider 252, which helps the layer stacking in the multiplication mechanism. The divider 252 divides the incoming two layers and flows into four quadrants. A function of the divider 252 is to divert the flow to stack the individual quadrants side-by-side and arrange them side-by-side in the x-y plane when exiting the outlet 254.

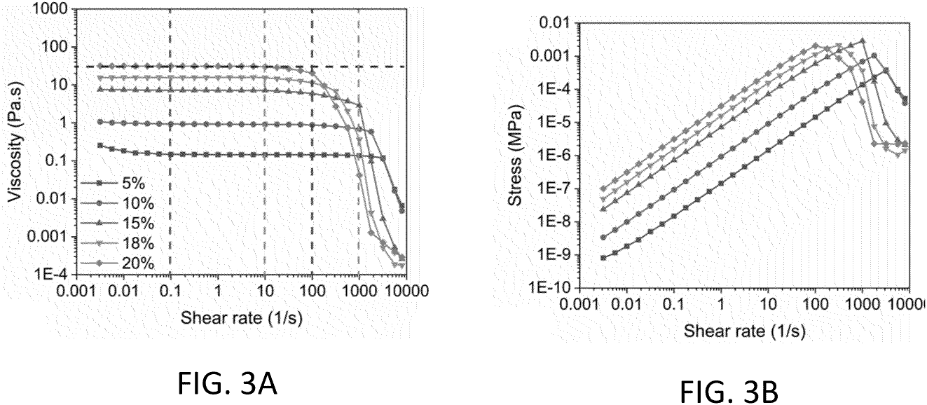

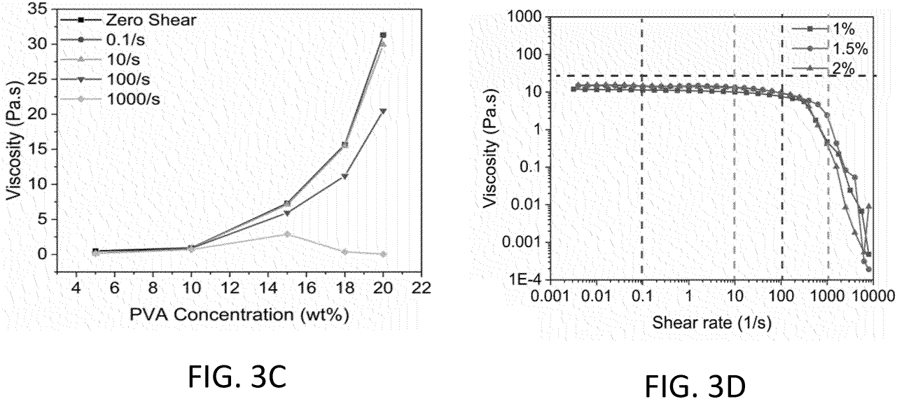

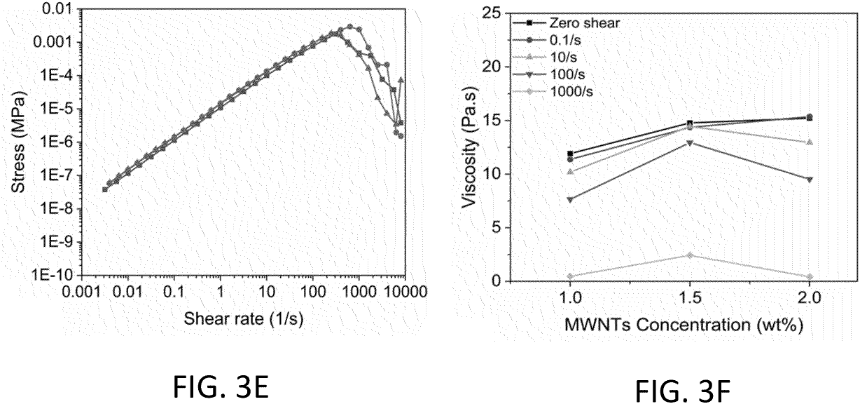

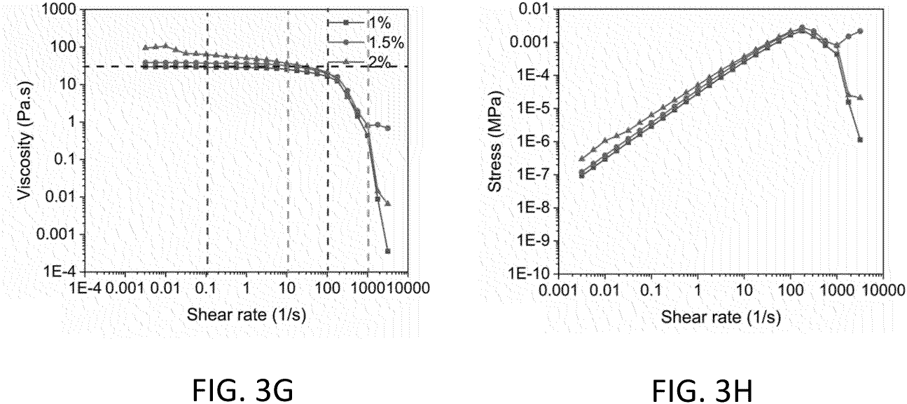

Printability and Layer Formability. Direct writing-based 3D printing relies at least in part on shear-thinning behavior of the inks to avoid clogging during deposition. Upon exiting the printing needle, the solutions develop viscoelastic properties for the printed objects to maintain their structural integrity. Controlling the viscosity and viscosity matching between layers is achieved for layered structures. The stability of the layers and interfaces depends in part on having a minimal viscosity difference between the feedstock solutions. FIGS. 3A-3I show the viscosity and stress of polymer solutions and nanotube suspensions. With increased polymer content in feedstock A, the PVA/DMSO solutions displayed increased viscosity as shown in FIG. 3A. The 20 wt% PVA/DMSO showed the highest viscosity of ~30 Pa.s at a shear rate of 10 /s as shown in FIGS. 3A-3C. Linear viscoelastic region (LVER) defined the linear shear stress-shear strain region (between the shear rates of 0-100 /s in FIG. 3B). The 5 wt% PVA/DMSO showed the longest LVER due to its dilute regime with the least entangled polymer chains and the poor structural stability. The 20 wt% PVA solutions showed the shortest LVER, beyond which a pseudoplastic region appeared due to molecular reorganizations with distinct shear-thinning benefiting 3D printing procedures.

A narrow viscosity gap or close viscosity matching between feedstock A and B is advantageous to avoid layer breakage during printing. Therefore, the feedstock B content was designed accounting for the fact that the inclusion of MWNTs would increase the viscosity. A percentage of 15 wt% and 18 wt% of PVA were prepared and tested with different MWNTs loading, respectively, as shown in FIGS. 3D-3F. Compared to 15 wt% pure PVA shown in FIGS. 3A-3C, 1 wt% MWNTs addition did not change the viscosity significantly as shown in FIG. 3D. The PVA solution and MWNTs suspension samples showed a viscosity of ~10 Pa.s at a shear rate of 10 /s. Higher MWNTs content increased the viscosity, e.g., up to 15 Pa.s at a shear rate of 1-100 /s at the MWNTs concentration of 2 wt% as shown in FIGS. 3D-3F. However, these MWNTs suspensions showed a lower viscosity than the 20 wt% PVA/DMSO across the entire shear procedure shown in FIGS. 3A and 3D. This microstructural instability would cause layer breakage during multiplication procedures, thus making it undesirable.

The 18 wt% PVA with varied MWNTs content showed a similar LVER to the pure polymer solutions shown in FIG. 3G. Like the 15 wt% PVA, the addition of the MWNTs in 18 wt% PVA did not disrupt the polymer chain networks (i.e., the linear shear stress-rate relationship in FIG. 3H). This microstructural stability was due to the polymer chain entanglements that would also retain their dimensional consistency after printing on the substrates as shown in FIG. 3H. The MWNTs content increased the viscosity of the 18 wt% PVA stably within the LVER (<200 /s) (e.g., 1 wt% MWNTs increased the viscosity to ~25 Pa.s, 1.5 wt% MWNTs increased to ~32 Pa.s, and the 2 wt% MWNTs increased to ~37 Pa.s at a shear rate of 10 /s). Other compositions, such as a higher concentration of MWNT (>2 wt%) in lower polymer solutions (<15 wt%), can be compatible with this innovative 3D printing method. This study only used 20 wt% PVA/DMSO and 1 wt% MWNT in 18 wt% PVA/DMSO to demonstrate printability and the composite properties; other compositions with similar viscosity may also find it feasible to print similar layered composite structures.

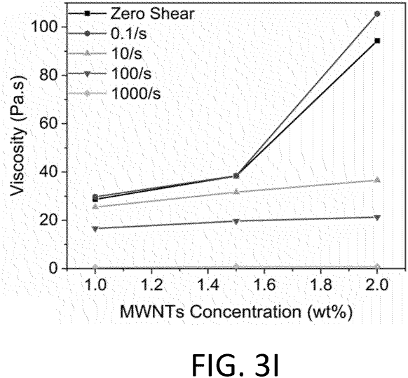

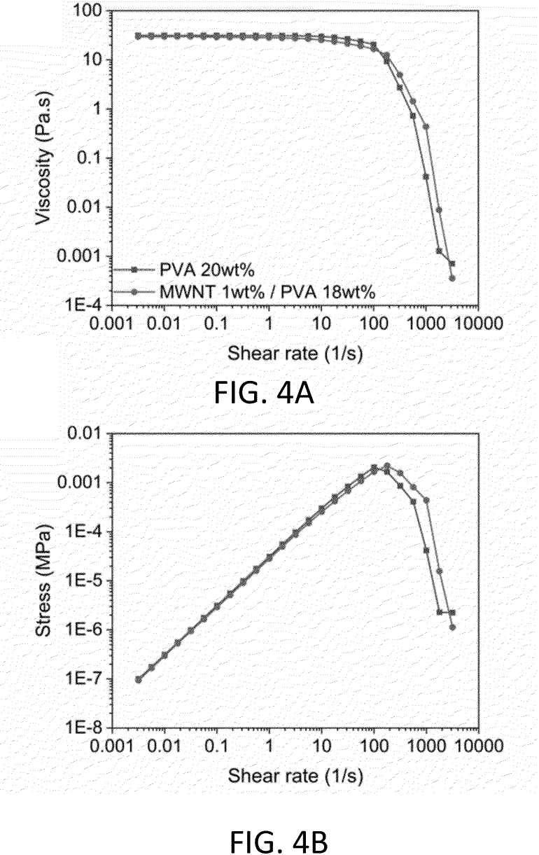

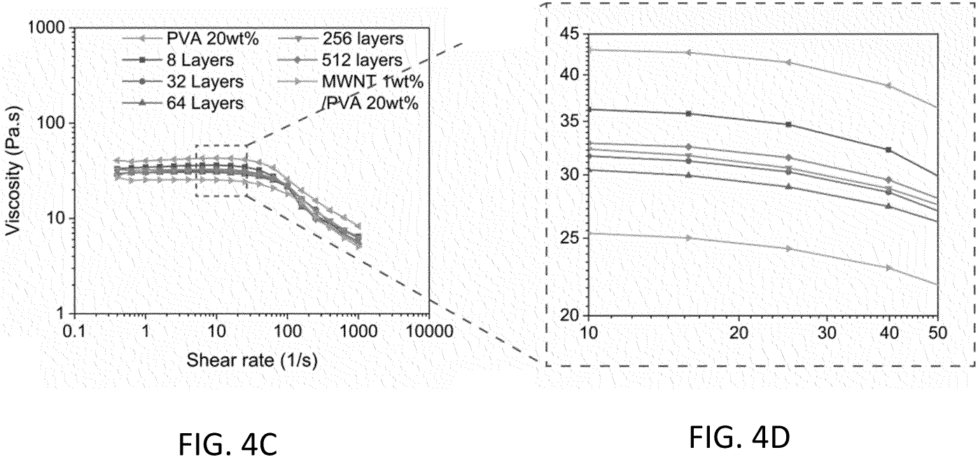

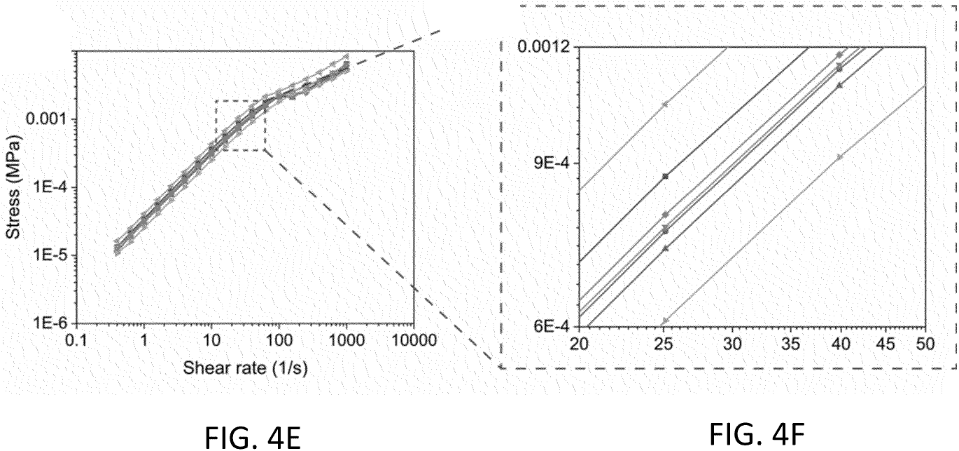

The feedstock rheology measured from the cone-and-plate geometry provided viscosity values under uniform shear. The feedstock A (e.g., 20 wt% PVA/DMSO) and feedstock B (e.g., 1 wt% MWNTs in 18 wt% PVA/DMSO) displayed matched viscosity as shown in FIGS. 4A and 4B. For further testing the layer interactions in the printing procedure, the multiplication process was mimicked in the rheology tests using a plate-and-plate geometry. The PVA/DMSO and MWNTs/PVA/DMSO were stacked on top of each other in different layers and tested compared to homogeneous solutions. The layers were produced on top of each other simply by attaching the layer multipliers in reverse to the spinneret. The viscosity and shear stress as a function of shear rate was shown in FIGS. 4C and 4D and FIGS. 4E and 4F, respectively. The 20 wt% PVA displayed the highest viscosity, e.g., ~43 Pa.s between a shear rate of 10⁻¹-30 /s, ~10 Pa.s higher in the plate-and-plate geometry than the cone-and-plate measurement shown in FIGS. 3A and 3C due to the shear stress distribution differences among these two measurement setups.

The 1 wt% MWNTs/18 wt% PVA/DMSO mixtures showed the lowest viscosity due to nanotubes’ lubrication effect. The 8-layered composites showed lower viscosity than the pure PVA as shown in FIGS. 4D and 4D. The increased layer numbers further decreased the friction among layers, e.g., 36 Pa.s for 8 layers, 32 Pa.s for 32 layers, and 30 Pa.s for 64 layers at a shear rate of 10 /s. The interfacial lubrication due to MWNTs diffusion between layers contributed to the friction decrease. However, the increase of layer numbers to 256 and 512 layers showed increased viscosity of 33 Pa.s and 34 Pa.s, respectively. This viscosity increase was attributed to nanotube dispersion difficulty that disrupted the layer structures and possibly more polymer chain entanglement as a result of diffusion at the layer interfaces. All the stacked layers showed similar LVER, which was necessary to maintain layer stability as shown in FIGS. 4E and 4F.

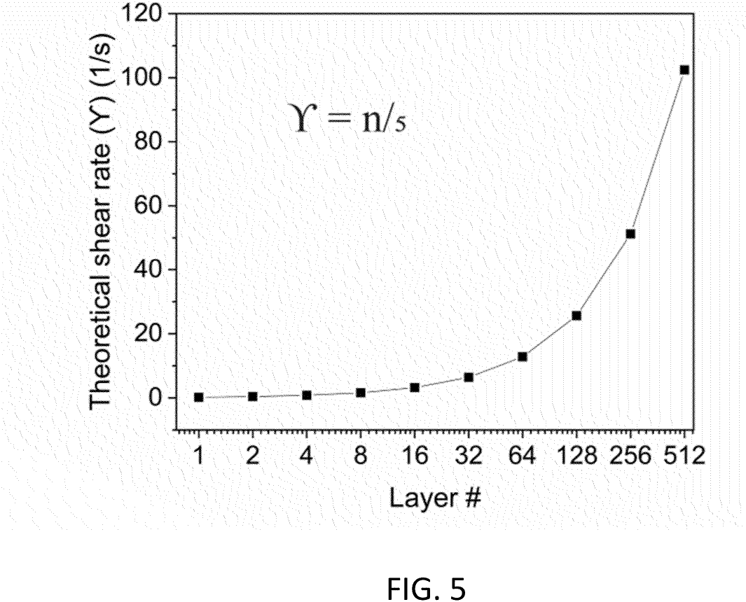

FIG. 5 shows the calculated shear rate as a function of the layer number, with 512-layered structures showing a shear rate of ~100 /s upon entering the 8^{th} multiplier. The associated shear rates are due at least in part to increasing layers (i.e., layer number 1-512, with the 1-layered structure for the pure polymer printing). The following equations give the shear rate of an individual layer entering each multiplier channel.

$$γ = \frac{v}{w} \qquad \text{(1)}$$

$$v = \frac{{v}_{o}}{A} = \frac{{v}_{o}}{h w / n} \qquad \text{(1)}$$

$$γ = \frac{{v}_{o} n}{{w}^{2} h} \qquad \text{(2)}$$

Here γ is the shear rate (/s), v is the flow velocity (mm/s), h is the channel height (mm), Vₒ is the volume flow rate of the feedstock controlled by the feeding system (mm³/s), w is the channel width (mm), and n is the number of multipliers. The height and width of each channel in the multiplier are 5 mm, respectively. The calculated shear rates show the flow behavior consistency between feedstock A and B, confirming the printing stability.

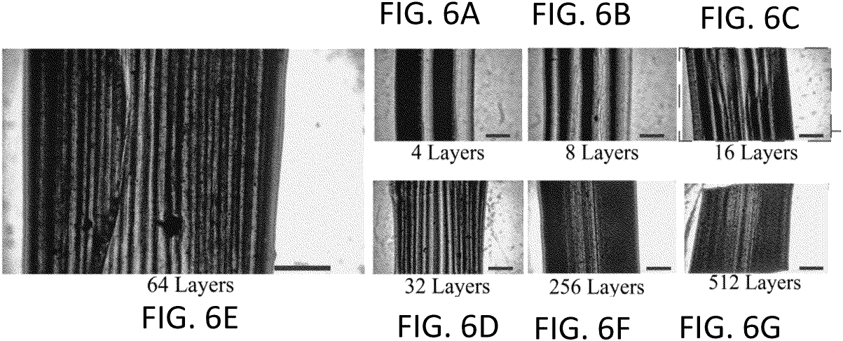

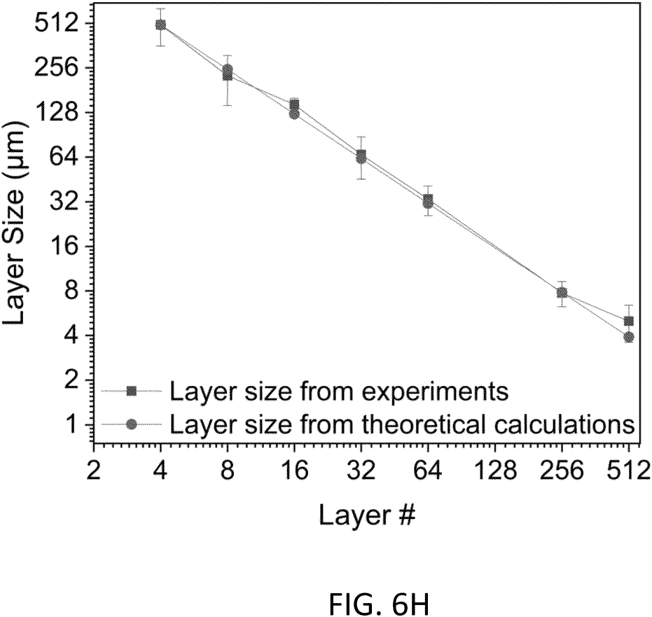

Structure and Morphology Studies. Composites with different number of layers shown in FIGS. 6A-6G were fabricated using the additive manufacturing printer and devices shown in FIGS. 1A-1C. Referring to FIG. 1B, the reducer 140 in the print head 120 determines the width and thickness of an individually printed line (e.g., 2 mm in width and 200 µm in thickness for one printing line). The 3D printing system prepared composites with a layer number of 4, 8, 16, 32, 64, 256, and 512. Referring to FIGS. 6A-6G, the light regions are the PVA and the dark regions are the MWNTs/PVA layers. In one example, as-printed thin-ply structures with continuous printing lines had a total ply size of 100 mm × 80 mm and 16 layers in each printing line. The as printed ply structure had an average layer thickness of ~164.6 ± 26.5 µm after 1 min of completion of the print, and -184.6 ± 15.3 µm after three hours of completion of the print. The layered structures exhibited high structural integrity and stable texture during a 3 hours exposure to air. This adoption of the solvent exchange-based gelation immediately fixed the shape and dimensions of printed structures, thus providing a higher-precision printing feature than these air-exposed samples.

The as-obtained MWNTs in DMSO suspensions showed high aggregates. The addition of 1 wt% PVA/DMSO to the MWNT suspensions yielded much improved the dispersion quality. The eventual MWNTs in feedstock B exhibited comparatively uniform MWNTs distributions, with random aggregates at a scale of 10 µm. These aggregates made processing a higher layer number than 512 (i.e., layer thickness at nanometers) challenging due to this simplified processing of nanotube dispersions, e.g., via a short-period sonication. The layer thickness values were calculable from the multiplications compared to the experimental measurements as shown in FIG. 6H. This comparison showed a high consistency between the experimental design and the real layer dimensions, with the 512-layered structures showing a single layer size of ~4 µm. The 4-layered composites showed a layer thickness of ~500 µm and the 64 layered samples exhibited a thickness of ~45 µm. This layer thickness is less than that achieved in most conventional 3D printers (e.g., > 200 µm). Based on the optical images shown in FIGS. 6A-6G and image analysis shown in FIG. 6H, composites with less than 64 layers showed distinct layers while the 256/512 layered composites had textured morphology. The increasing layer numbers also improved the layer consistency, corresponding to more stabilized printing width and layer width as shown in FIG. 6H.

MWNT Alignment and Layer-Layer Interactions. Raman analysis was conducted on the as-printed samples to find the preferential alignment factor. MWNTs nanomaterials have the depolarization effect, and Raman spectra can reflect their orientation and distribution quality. The 64- and 256-layered structures as the layered samples were placed with different laser-layer angles of θ=0° and θ=90°. It was challenging to perform Raman mapping for layer numbers smaller than 64 layers due to the larger layer size (i.e., >50 µm) than the polarization laser spot size (i.e., 1.2 µm). The Raman modes in the VV configuration (defined here as polarization of the incident light parallel to the fiber axis) exhibit a maximum intensity when the incident light is polarized in the longitudinal axis (defined here as along with the layered structures), while the Raman intensity is significantly suppressed when the laser is polarized in the lateral axis (defined here as perpendicular to the layer directions). The color mapping reflected the MWNTs conformation variations and their corresponding intensity spectra were plotted.

MWNTs have feature peaks of the D- and G-bands at 1353 cm⁻¹ and 1580 cm⁻¹, respectively. Based on the dependency of the MWNT signature peaks on polarization angles, such Raman spectra indicated superior nanotube alignment at the interfaces compared to the inner region of the MWNTs/PVA layer. Furthermore, with an increase in the layer numbers (i.e., 4 to 64), the interfacial area increased and contributed to better MWNTs alignment.

The 256-layered structures showed less than 10 µm-thick PVA layers in Raman mapping, consistent with the optical microscopy (OM) observation and theoretical calculations shown in FIG. 6H. As compared to the 64-layered structures, the 256-layered structures showed much stronger MWNTs diffusion into the PVA regions. The enhanced D-band and G-band intensities also indicated a diffusion of the MWNTs between the layers blurring the interfaces. The diminished interface deteriorated the interfacial alignment effect observed for the 64 layers. The θ=0° peak intensity observed little difference between the layer interface and the layer core regions for the 256-layered MWNTs/PVA regions. The ratio of averaged intensities between θ=0° and θ=90°, I₀/I₉₀, is usually a facile indication of preferential orientations. I₀/I₉₀ ratio of the D-band for the 64 and 256 layers was calculated to be 2.17 and 1.71, respectively, indicating a higher angular dependency for the 64 layers, thus a better MWNTs alignment.

Modulated Differential Scanning Calorimetry. MDSC was used to detect the composites’ crystallization behavior and layer numbers’ influence on the crystal formation. Melting peaks appeared in samples at certain temperatures (e.g. ~170-200° C.). The observation of two melting peaks suggested two primary polymer crystals of different sizes. The lower temperature peak (Tₘ₁, 175-190° C.) is associated with a smaller enthalpy for melting the smaller crystal size and the higher temperature peak (Tₘ₂, 220-250° C.) with a larger enthalpy for the bigger crystal size. The influences of layer numbers on the two melting peaks are consistent. With the increase of the layer numbers from 4 to 64 layers, the melting temperatures approximately decreased due to more interactive interfaces. However, the lack of uniform layers in the 256- and 512-layered structures disrupted the MWNTs distributions and orientations and led to varied transition temperatures. Table 1 lists the enthalpy, crystallinity, and primary crystal size. The degree of crystallinity (X_{c}) was obtained via the following equation.

$${X}_{c} = \frac{Δ H}{Δ {H}_{c}} \times 100 \qquad \text{(3)}$$

Here ΔH is the melting enthalpies obtained from a normalized heat flow curve, and ΔH_{c} is the enthalpy for 100% crystalline PVA, 161 J/g.

The crystallization peak of the semi-crystalline polymer reflected the crystal size variation, relevant to their responses to the temperature sweeping. The larger the crystal size, the higher the melting peak; the narrower the size distribution, the smaller the full-peak-width at half maximum. The averaged lamellar thickness (L_{c}) can be calculated based on the following Gibbs-Thomson equations.

$${T}_{m} = {T}_{m}^{o} \left(1 - \frac{2 σ}{Δ {H}_{m} L}\right) \qquad \text{(4)}$$

$$L = \frac{2 σ Τ m °}{Δ {H}_{m} \left({T}_{m}^{o} - {T}_{m}\right)} \qquad \text{(5)}$$

Here Tₘ is the measured melting temperature for a given lamellae thickness L, Tₘ^{o} is the equilibrium melting temperature of an infinitely thick crystal (i.e., 249° C.), σ is the surface free energy per unit area of the crystal basal plane (i.e., 37.2 × 10⁻³ J/m³), and ΔHₘ is the enthalpy of fusion per unit volume (i.e., 166.3 × 10⁶ Jm⁻³). The calculated values of crystallinity (X_{c}), and lamella thickness (L), along with melting temperature (Tₘ) are shown in Table 1.

TABLE 1

MDSC analysis of composites containing 4-512 layers film and PVA film

| Layers | Heating Cycles in the MDSC tests | | | | | | | |
|---|---|---|---|---|---|---|---|---|
| | Tₘ₁ (°C) | Tₘ₂ (°C) | ΔH₁ (J/g) | ΔH₂ (J/g) | X_{c1} (%) | X_{c2} (%) | L_{c1} (nm) | L_{c2}(nm) |
| 1 (PVA) | 175.70 | 236.69 | 31.04 | 67.01 | 19.28 | 41.62 | 3.19 | 18.98 |
| 4 | 192.63 | 233.93 | 59.00 | 57.88 | 36.65 | 35.95 | 4.14 | 15.50 |
| 8 | 187.93 | 222.69 | 51.35 | 61.82 | 31.89 | 38.40 | 3.83 | 8.88 |
| 16 | 182.53 | 220.23 | 54.62 | 63.57 | 33.93 | 39.48 | 3.51 | 8.12 |
| 32 | 186.83 | 223.86 | 59.14 | 64.08 | 36.73 | 39.80 | 3.76 | 9.29 |
| 64 | 181.31 | 223.94 | 45.06 | 68.92 | 27.99 | 42.81 | 3.45 | 9.32 |
| 256 | 187.55 | 218.44 | 49.43 | 64.56 | 30.70 | 40.10 | 3.80 | 7.64 |
| 512 | 188.01 | 246.05 | 32.54 | 56.57 | 20.21 | 35.14 | 3.83 | N/A |

Note: The enthalpy for the fully crystallized PVA polymers is 161 J/g.

The crystallinity at the low-temperature exotherm (Tₘ₁, 175-190° C.) was between 20% - 37%. PVA showed the lowest crystallinity at 19.28%, and the layered samples showed increased crystallinity. The corresponding crystal size also increased from 3.19 nm in PVA to a range of 3.80 - 4.14 nm in the composite layers as provided in Table 1. The smaller crystals may have formed due to the breakup of small grains/clusters caused by shear forces during the layer formation process and confinement effects. The higher exotherm (Tₘ₂, 220-250° C.) indicated much larger crystals, with the size varying 7-19 nm than that for the low-temperature exotherm (i.e., 3 - 5 nm). The melting temperatures (Tₘ₂), crystallinity (X_{c2}), and crystal size (L_{c2}) dropped from the pure PVA to the composite layers. The crystal sizes calculated here were the average of different crystal planes. Thus, the XRD data may clarify the crystallinity and crystal size variations in specific crystal planes.

$${\text{X}}_{\text{c\_XRD}} = \frac{{\text{A}}_{\text{c}}}{{\text{A}}_{\text{c}} + {\text{A}}_{\text{a}}} \qquad \text{(6)}$$

$${\text{L}}_{\text{XRD}} = \frac{\text{k} \text{λ}}{\text{β} \text{Cos} \text{θ}} \qquad \text{(7)}$$

$$2 \text{dSin} \text{θ =} \text{n} \text{λ} \qquad \text{(8)}$$

Here A_{c} is the crystalline peak fitting area, Aₐ is the amorphous peak fitting area, λ is the X-ray wavelength, θ is the Bragg’s angle, β is the angular full-width-at-half-maximum (FWHM) intensity, n is 1, and k is a constant with a value of 0.9. The diffraction peaks were observed at 2θ angles ~ 16.08°, 19.87°, and 41.11° corresponding to crystal planes of (001), (101), and (111). The amorphous peak was observed at 2θ angles ~22.76°. These crystal planes were fitted based on lattice contestants of a = 7.81 Å, b = 2.52 Å, c = 5.51 Å, and β = 91° 42 for an optimized monoclinic structure of PVA.

The crystallinity, crystal sizes, and d-spacing calculated using the XRD spectra after peak fitting are tabulated in Table 2. There was a crystallinity increase from the PVA (~32.37%) to the layered composites (~40 - 44%), with 64 layers showing the highest crystallinity (43.95%) among the layered composite. However, the layer numbers did not affect the crystallinity significantly as shown in Table 2. The high crystallinity in the layered composites is possibly due to higher polymer chain confinement and nanotube nucleation effects within each layer. A reverse trend is observed in cases of crystal size and d-spacing from PVA to layered composites. The crystal sizes from two planes (i.e., 101 (2θ ~ 19.87°) and 001 (2θ ~ 16.08°) along b-axis) influence the PVA mechanics the most because of their alignment along the tension direction. PVA showed the largest crystal size in both the planes (i.e., 5.53 nm for (101) and 3.221 nm for (001)). In comparison, the layered composites had a crystal size of 2.390-2.676 nm in the (001) and 4.310-4.985 nm in the (101) planes. The smaller d-spacing in layered composites also suggested more closely packed crystals. The smaller crystal size (e.g., based on the Hall-Petch relationship) and d-spacing (e.g., higher close packing) usually lead to higher material strength.

TABLE 2

XRD analysis of composites containing 4-512 layers films and PVA film

| Layers | X_{c_XRD} (%) | L_{XRD} (nm) | | d (nm) | |
|---|---|---|---|---|---|
| | | (101) (2θ ~ 19.87°) | (001) (2θ ~ 16.08°) | (101) (2θ ~ 19.87°) | (001) (2θ ~ 16.08°) |
| 1 (PVA) | 32.37 | 5.531 | 3.221 | 0.2295 | 1.7708 |
| 4 | 41.97 | 4.985 | 2.464 | 0.2280 | 1.3548 |
| 8 | 43.03 | 4.372 | 2.461 | 0.2289 | 1.3533 |
| 16 | 43.23 | 4.702 | 2.461 | 0.2283 | 1.3533 |
| 32 | 40.54 | 4.677 | 2.483 | 0.2294 | 1.3653 |
| 64 | 43.95 | 4.763 | 2.448 | 0.2283 | 1.3463 |
| 256 | 42.17 | 4.727 | 2.390 | 0.2282 | 1.3262 |
| 512 | 41.82 | 4.310 | 2.676 | 0.2300 | 1.4718 |

X_{c_XRD}, crystallinity from XRD; L_{XRD}, crystal size from XRD fitting; d, d-spacing or the crystal plane distance from XRD fitting.

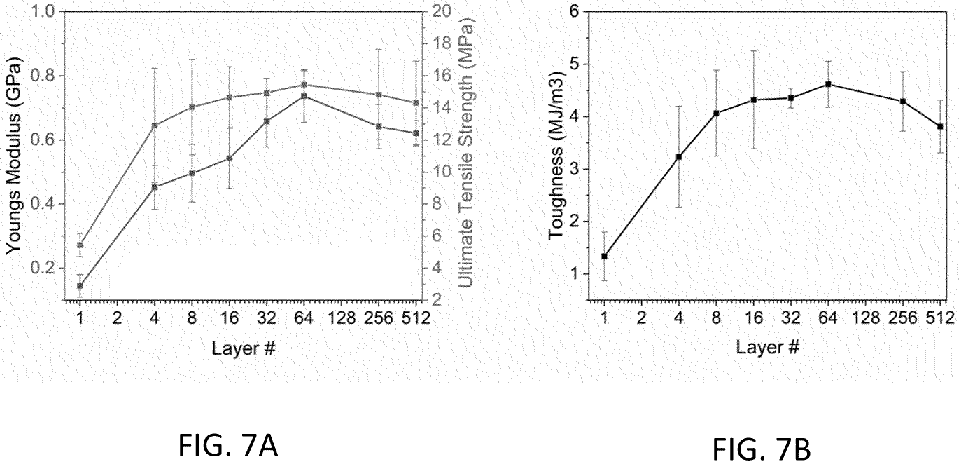

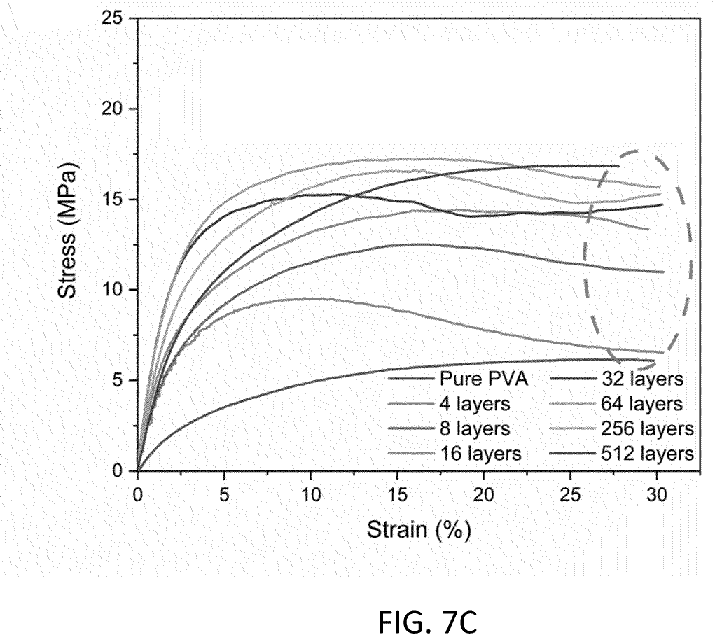

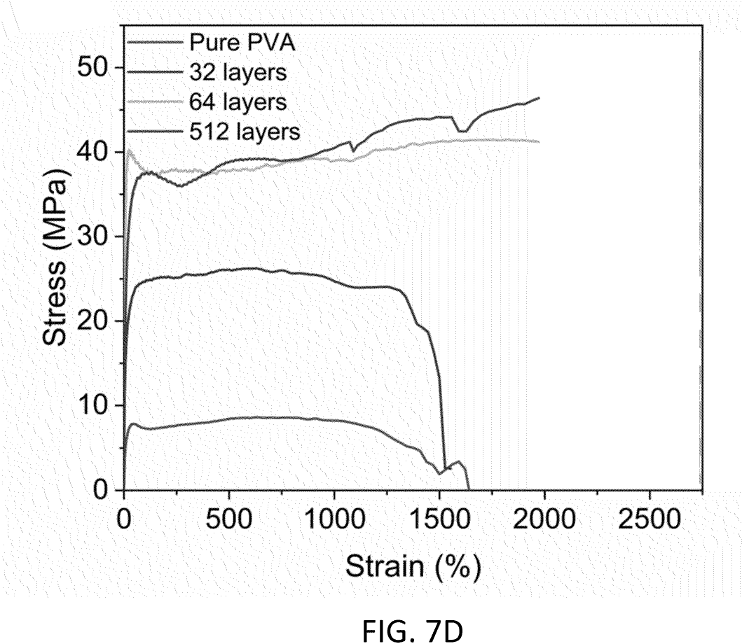

Tensile Test. The PVA and composites as-printed showed high stretchability with strain values quickly exceeding the general tensile tester capabilities (e.g., >2000% strain). Thus, these samples were first tested with a gauge length of 15 mm with a tensile strain of 30%, only to expose the elastic regions as shown in FIG. 7A and Table 3. FIG. 7A shows Young’s modulus and ultimate tensile strength (UTS) for pure PVA and multilayered composites. With the same MWNTs concentration (i.e., 1 wt% or 0.5 vol%), the layered composites displayed modulus and strength values with high dependence on the layer numbers as shown in FIG. 7A. Pure PVA showed the lowest modulus (0.145 ± 0.035 GPa) and strength (5.44 ± 0.72 MPa). In comparison, the 64-layered structures showed ~5 times higher modulus (0.737 ± 0.082 GPa) and ~3 times higher strength (15.45 ± 0.87 MPa), suggesting the MWNTs′ reinforcement effect of ~ 240 GPa for modulus and ~ 4 GPa for strength, respectively, based on simple composite mechanics rule-of-mixture given by Eq. 10.

$${E}_{c} = {E}_{m} {V}_{m} + {E}_{f} {V}_{f} \qquad \text{(9)}$$

The corresponding reinforcement efficiency factor is calculated 16.33. Though smaller than the intrinsic values of MWNTs (e.g., Young’s modulus ~500-1000 GPa and strength ~20-100 GPa, respectively), the MWNTs materials in this analysis were dispersed using only simple sonication and involved aggregates in the layered structures. The consistent increase of modulus and strength from pure PVA to 4-layered to 64-layered structures was primarily due to thinner layer thickness and more interactive interfaces. The constant MWNT concentration among different composites does not influence the reinforcement effects. However, the 64-layered structures showed preferential nanotube alignment along the axial nanotube direction, much enhanced the composite mechanics (i.e., Halpin-Tsai model). Note that the composites displayed even better composite mechanics when these MWNTs dispersed across the printing area as (as seen in Table 3), considering their similar nanotube alignment.

TABLE 3

Mechanical properties of printed composite*

| Young’s Modulus (GPa) | | | Ultimate Tensile Strength (MPa) | | |
|---|---|---|---|---|---|
| PVA | PVA/MWNTs | % Improvement | PVA | PVA/MWNTs | % Improvement |
| 0.145 | 0.453 | 212.41 | 5.44 | 12.90 | 137.13 |
| | 0.496 | 242.07 | | 14.05 | 158.27 |
| | 0.543 | 274.48 | | 14.65 | 169.30 |
| | 0.658 | 353.78 | | 14.95 | 174.82 |
| | 0.737 | 408.28 | | 15.45 | 184.01 |
| | 0.642 | 342.76 | | 14.83 | 172.61 |
| | 0.621 | 328.28 | | 14.31 | 163.05 |

^{∗}(4 - 512 layers) - composites containing 1 wt% CNTs in PVA

The 256- and 512-layered structures showed a slight decrease in averaged modulus and strength values shown in FIG. 7A. Also, the standard deviations during the tension tests were more significant than the 64-layered structures. The thinner layer thickness resulted in more homogeneous MWNTs distributions. However, Raman analysis showed interlayer diffusion and the less orientated MWNTs than the 64-layered structures. The energy absorption was calculated based on a tension of 30% (E_{30%strain}) showed the same trend, with the 64-layered structures displaying the highest E_{30%strain} capability during tension (e.g., 3.5 times increase from PVA to the 64-layered structures, as shown in FIG. 7B). Examples of tension curves up to 30% strain and a gauge length of 15 mm are shown in FIG. 7C. However, none of the samples showed a fracture due to the samples’ stretchability. A much-reduced gauge length of ~2.5 mm was used to demonstrate the fracture resistance of the 3D printed layer structures shown in FIG. 7D. The PVA fractured ~1500%, and the 32-layered structures failed at ~1550%. However, the maximum displacement of 2000% did not break the samples with a higher layer number than 64, showing their high fracture resistance and E_{30%strain} shown in FIG. 7D. A smaller gauge length than 2 mm may get the 64-layered structures fractured, but the stress concentration effects would cause the breakage at the clamping point, and thus, these fracture tests were not done. The mechanical properties of the PVA/0.5 wt% MWNTs are shown in Table 4. This demonstration of the layered composites showed the highest mechanics improvement, namely, a maximum of ~408% increase in modulus and a ~184% increase in strength, as compared to the general modulus improvement up to ~121% for modulus and ~133% for strength from other studies. The layer structures in composite samples provided high packing factor and alignment of nanotubes within each layer and facilitated the stress transfer efficiency from CNTs to polymers, rendering high mechanical property enhancement as shown in FIGS. 7A-7D.

TABLE 4

Mechanical properties of the as-printed samples

| Layers | Young’s Modulus (GPa) | Ultimate Tensile Strength (MPa) | Energy absorption @ 30% strain (MJ/m3) |
|---|---|---|---|
| 1 (PVA) | 0.145 ± 0.035 | 5.44 ± 0.72 | 1.334 ± 0.462 |
| 4 | 0.453 ± 0.069 | 12.90 ± 3.57 | 3.236 ± 0.865 |
| 8 | 0.496 ± 0.090 | 14.05 ± 2.97 | 4.066 ± 0.818 |
| 16 | 0.543 ± 0.095 | 14.65 ± 1.91 | 4.318 ± 0.928 |
| 32 | 0.658 ± 0.080 | 14.95 ± 0.89 | 4.355 ± 0.190 |
| 64 | 0.737 ± 0.082 | 15.45 ± 0.87 | 4.618 ± 0.437 |
| 256 | 0.642 ± 0.069 | 14.83 ± 2.81 | 4.290 ± 0.567 |
| 512 | 0.621 ± 0.039 | 14.31 ± 2.60 | 3.812 ± 0.501 |
| D₄ | 0.489 ± 0.050 | 13.54 ± 1.50 | 3.511 ± 0.389 |
| D₆₄ | 0.780 ± 0.075 | 18.59 ± 2.38 | 5.225 ± 0.323 |

Particular embodiments of the subject matter have been described. Other embodiments, alterations, and permutations of the described embodiments are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results.

Accordingly, the previously described example embodiments do not define or constrain this disclosure. Other changes, substitutions, and alterations are also possible without departing from the spirit and scope of this disclosure.

What is claimed is:

1. An additive manufacturing print head comprising:
a spinneret defining a first channel configured to receive a first feedstock and a second channel configured to receive a second feedstock, wherein the spinneret is configured to provide a bilayer extrudate comprising a layer of the first feedstock in direct contact with a layer of the second feedstock;
a minimizer configured to receive the bilayer extrudate from the spinneret and to reduce a flow area of bilayer extrudate transverse to a flow direction of the bilayer extrudate; and
a multiplier configured to transform the bilayer extrudate from the minimizer to a multilayer extrudate, wherein the multilayer extrudate comprises alternating layers of the first feedstock and the second feedstock.

2. The additive manufacturing print head of claim 1, further comprising a reducer configured to receive the multilayer extrudate from the multiplier and to modify the dimensions of the multilayer extrudate in a plane transverse to the flow direction of the multilayer extrudate.

3. The additive manufacturing print head of claim 1, wherein the multiplier is configured to transform the bilayer extrudate to a four-layer extrudate.

4. The additive manufacturing print head of claim 1, further comprising an additional multiplier configured to receive the multilayer extrudate from the multiplier and to double a number of alternating layers of the multilayer extrudate.

5. The additive manufacturing print head of claim 4, further comprising a reducer configured to receive the multilayer extrudate from the additional multiplier and to modify the dimensions of the multilayer extrudate in a plane transverse to the flow direction of the multilayer extrudate.

6. The additive manufacturing print head of claim 4, wherein the multiplier and the additional multiplier are configured to transform the bilayer extrudate to an eight layer extrudate.

7. The additive manufacturing print head of claim 1, comprising one or more additional multipliers, wherein a total number of multipliers is n.

8. The additive manufacturing print head of claim 7, wherein the multiplier and the one or more additional multipliers are configured to transform the bilayer extrudate to a multilayer extrudate having 2(ⁿ⁺¹) layers.

9. The additive manufacturing print head of claim 1, further comprising (n-1) additional multipliers coupled in series, wherein each of the (n-1) additional multipliers is configured to double a number of alternating layers of the multilayer extrudate provided to the each of the (n-1) additional multipliers.

10. The additive manufacturing print head of claim 9, further comprising a reducer configured to receive the multilayer extrudate from the (n-1) additional multipliers and to modify a dimension of the multilayer extrudate in a plane transverse to the flow direction of the multilayer extrudate.

11. A printer comprising the print head of claim 1.

12. A method of fabricating a multilayer extrudate, the method comprising:
co-extruding a first feedstock and a second feedstock to yield a bilayer extrudate, wherein the bilayer extrudate comprises a layer of the first feedstock in direct contact with a layer of the second feedstock; and
providing the bilayer extrudate to one or more multipliers to yield a multilayer extrudate, wherein the multilayer extrudate comprises alternating layers of the first feedstock and the second feedstock.

13. The method of claim 12, wherein the first feedstock and the second feedstock are immiscible.

14. The method of claim 13, wherein a difference in viscosity between the first feedstock and the second feedstock at room temperature is approximately zero.

15. The method of claim 12, wherein the first feedstock, the second feedstock, or both comprise a polymer and a solvent.

16. The method of claim 15, wherein the polymer comprises polyvinyl alcohol.

17. The method of claim 16, wherein the solvent comprises dimethyl sulfoxide.

18. The method of claim 12, wherein the first feedstock, the second feedstock, or both comprise nanostructures.

19. The method of claim 18, wherein the first feedstock, the second feedstock, or both are dispersions.

20. The method of claim 12, further comprising polymerizing the multilayer extrudate to yield a multilayer structure.

21. The method of claim 12, wherein providing the multilayer extrudate to the one or more multipliers comprises providing the multilayer extrudate to n multipliers in series, and the multilayer extrudate comprises 2(ⁿ⁺¹) alternating layers of the first feedstock and the second feedstock.
